(19) United States
(12) Patent Application Publication
(10) Pub. No.: US 2021/0371179 A1
(43) Pub. Date: Dec. 2, 2021

(54) RESEALABLE BAG

(71) Applicant: Pascal Diego Valerio, San Diego, CA (US)

(72) Inventor: Pascal Diego Valerio, San Diego, CA (US)

(21) Appl. No.: 17/333,778

(22) Filed: May 28, 2021

Related U.S. Application Data
(60) Provisional application No. 63/094,604, filed on Oct. 21, 2020.
(60) Provisional application No. 63/049,375, filed on Jul. 8, 2020.
(60) Provisional application No. 63/031,639, filed on May 29, 2020.

(51) Int. Cl. B65D 75/66; B65D 75/26; B31B 70/00

(52) U.S. Cl. CPC B65D 75/66; B65D 2575/586; B31B 70/004; B65D 75/26

(57) ABSTRACT

The resealable bag has a main body and at least one flexible member that is one of attached to the main body, disposed on the main body, and embedded in the main body. The resealable bag is selectively positionable between an open, unsealed position and a closed, sealed position. When the resealable bag is in the closed, sealed position, the at least one flexible member is in a deformed shape. Advantageously, the resealable bag can be repeatedly sealed and unsealed as desired without the use of additional integrated or non-integrated sealing mechanisms.

### CROSS-REFERENCE TO RELATED APPLICATIONS

This application claims the benefit of U.S. Provisional Application Ser. No. 63/163,406, filed on Mar. 19, 2021, U.S. Provisional Application Ser. No. 63/094,604, filed on Oct. 21, 2020, U.S. Provisional Application Ser. No. 63/049,675, filed on Jul. 9, 2020, and U.S. Provisional Application Ser. No. 63/031,639, filed on May 29, 2020. The entire disclosure of each of the above applications is incorporated herein by reference.

### FIELD

The present disclosure relates generally to flexible packaging and, more specifically, to a resealable bag including at least one flexible member adapted to maintain the resealable bag in a closed configuration.

### INTRODUCTION

This section provides background information related to the present disclosure which is not necessarily prior art.

A large variety of packaging solutions are available and used in industries such as food and beverage, cosmetics and personal care, fashion, and pharmaceutical and healthcare. Flexible packaging such as bags and pouches, for example, is widely used in the food industry for products such as chips and other snack foods, cereal, coffee, bread, and other food items. Flexible packaging for food items provides efficient storage and allows a user to easily access the contents of the flexible packaging. However, the food items contained in flexible packaging often do not remain fresh once the flexible packaging has been opened because the flexible packaging naturally remains in an open position.

It is known to include external, non-integrated closing mechanisms with flexible packaging. For example, certain flexible packaging may come with one or more twist ties, bag closures, elastic bands, or adhesives. In one example, as described in U.S. Pat. No. 3,822,441 to Paxton, a plastic clip with a narrow opening and an internal aperture is wrapped around the neck of a flexible bag. However, these non-integrated closing mechanisms often do not function properly and break throughout the life of the items being stored, are easy to lose, and do not always prevent the items from spilling out of the flexible packaging.

It is also known to include an integrated closing mechanism with flexible packaging. In one example, as described in U.S. Pat. No. 3,266,711 to Song, an elongate male member extends transversely across a mouth of a bag and connects to a female member. A portion of the bag is maintained in a closed position when the male and female members are pressed together. In another example, as described in U.S. Pat. No. 3,256,941 to Rivman, a pressure-sensitive adhesive disposed on a flap adjacent an opening of a bag is used to maintain a flexible package in a closed position. However, these integrated closing mechanisms are often expensive to manufacture, ineffective or faulty, and can be difficult or cumbersome for kids, elderly people, and the general population to use.

Accordingly, there is a continuing need for a resealable bag that includes an integrated, low-cost closing mechanism that effectively maintains the resealable bag in a closed position. Desirably, the resealable bag is easy-to-use and adaptable throughout the life of the items being stored.

### SUMMARY

In concordance with the instant disclosure, a resealable bag that is easy-to-use, adaptable throughout the life of the items being stored, and that includes an integrated, low-cost closing mechanism that effectively maintains the resealable bag in a closed position, has surprisingly been discovered.

In one embodiment, a resealable bag includes a main body and at least one flexible member that is one of attached to the main body, disposed on the main body, and embedded in the main body. The resealable bag is selectively positionable between an open, unsealed position and a closed, sealed position. When the resealable bag is in the closed, sealed position, the at least one flexible member is in a deformed shape.

In another embodiment, a system for manufacturing a resealable bag includes a dispensing mechanism adapted to dispense a panel of flexible material and a machine adapted to form the panel of flexible material into the resealable bag. The resealable bag has a main body and a flexible member that is one of attached to the panel of flexible material, disposed on the panel of flexible material, and embedded in the panel of flexible material.

In a further embodiment, a method of manufacturing a resealable bag includes the steps of providing a panel of flexible material and manipulating the panel of flexible material into the resealable bag. The resealable bag has a main body and a flexible member that is one of attached to the panel of flexible material, disposed on the panel of flexible material, and embedded in the panel of flexible material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a rear perspective view of a resealable bag according to one embodiment of the present disclosure, the resealable bag in a closed, un-opened first position;

FIG. 1B is a side perspective view of the resealable bag shown in FIG. 1A, the resealable bag in a re-sealed, closed second position;

FIG. 1C is a rear perspective view of the resealable bag shown in FIG. 1A, the resealable bag in an unrolled and unsealed, open third position;

FIG. 1D is a top elevational view of the resealable bag shown in FIG. 1A, the resealable bag shown with a top section of a second end of the main body removed;

FIG. 2 is a rear perspective view of a panel of the resealable bag shown in FIG. 1A;

FIG. 3 is a side perspective view of a plurality of layers and a flexible member of a resealable bag according to another embodiment of the present disclosure;

FIG. 4 is a top perspective view of a flexible member of the resealable bag shown in FIG. 1A;

FIG. 5 is a front perspective view of a resealable bag according to another embodiment of the present disclosure, the resealable bag shown with a section of the outer layer of the main body removed;

FIG. 6 is a front perspective view of a resealable bag according to another embodiment of the present disclosure, the resealable bag shown with a section of the outer layer of the main body removed;

FIG. 7 is a front perspective view of a resealable bag according to another embodiment of the present disclosure;

FIG. 8 is a rear perspective view of a panel of a resealable bag according to another embodiment of the present disclosure;

FIG. 9 is a side perspective view of a plurality of layers and two flexible members of a resealable bag according to another embodiment of the present disclosure;

FIG. 10 is a side perspective view of a system for making a resealable bag according to another embodiment of the present disclosure;

FIG. 11 is a side perspective view of a resealing layer of a resealable bag according to another embodiment of the present disclosure;

FIG. 12 is a method of making a resealable bag according to another embodiment of the present disclosure;

FIG. 13 is a method of making a resealable bag according to another embodiment of the present disclosure; and

FIG. 14 is a method of making a resealable bag according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

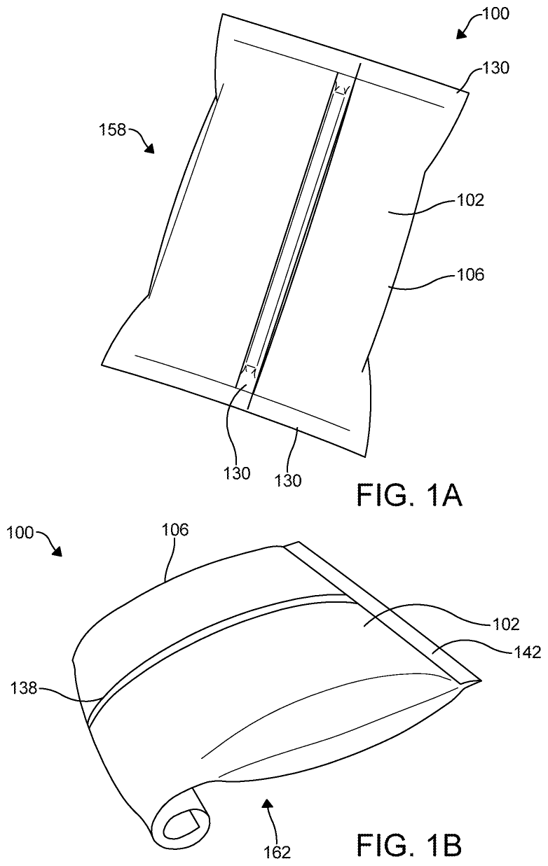

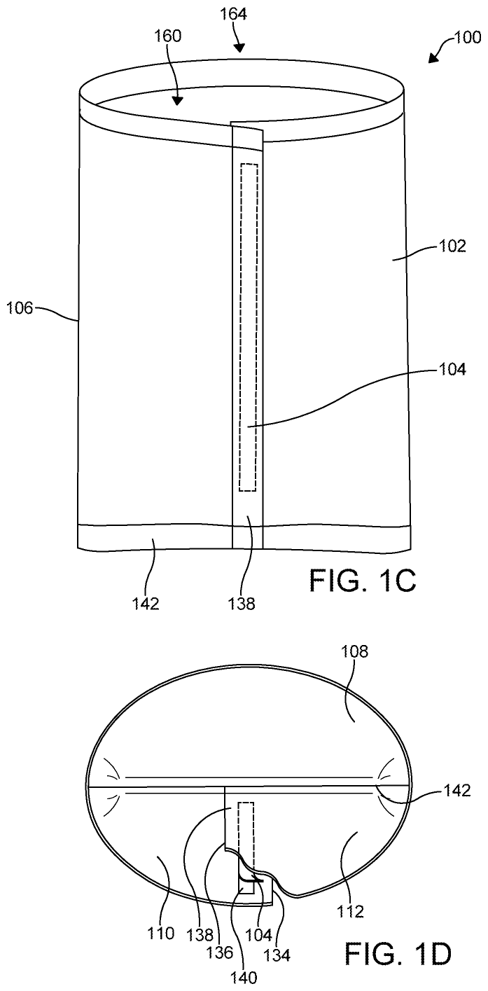

With reference to FIGS. 1-11, a resealable bag 100 including a main body 102 and at least one flexible member 104 is shown. The resealable bag 100 may be used in a variety of different industries and for a variety of end uses. As non-limiting examples, the resealable bag 100 may be useful in industries including food and beverage, pet care, cosmetics, health and beauty, and pharmaceutical and healthcare, as well as for any appropriate consumer, household, and industrial products. Though the resealable bag 100 is shown throughout the drawings and described in the specification as a bag for snacks and other food items, it should be further appreciated that food storage is one non-limiting example in which the resealable bag 100 may be employed. A skilled artisan may select any other suitable application for the resealable bag 100, as desired. Likewise, aspects of the resealable bag 100, including aspects relating to size, shape, and dimensions thereof, can be tailored by one skilled in the art as necessary to accommodate various sizes, shapes, and dimensions of the respective product(s) to be contained therein.

It should be further appreciated that the resealable bag 100 may be any suitable shape, size, and configuration, as desired, and may not resemble a conventional bag according to certain embodiments. For example, pouches, sleeves, wraps, and other pliable product containers are contemplated in the present disclosure. Additionally, the dimensions of the resealable bag 100 may be any suitable dimensions for the desired end use. Advantageously, the resealable bag 100 may be scaled, as needed.

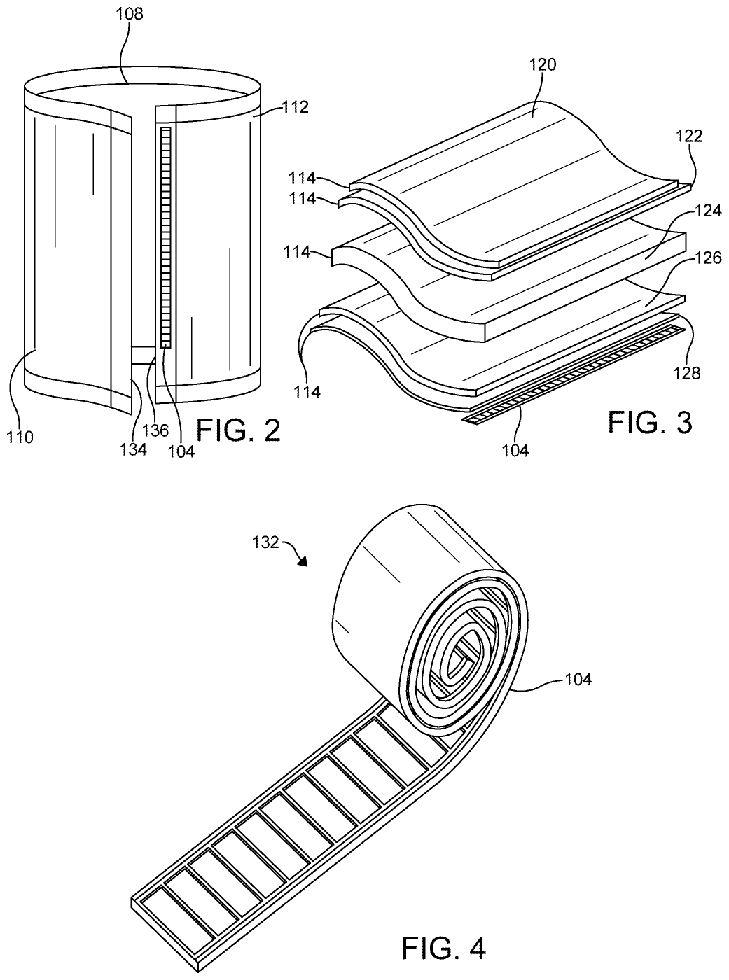

The main body 102, according to certain embodiments, may be formed from a panel 106, as shown in FIGS. 1A, 1B, 1C, 1D, and 2. The panel 106 may be fabricated using any suitable material or materials, as dictated by the desired end use. As non-limiting examples, polymer films, paper, plastic, aluminum foil, cellulosic film, bioplastic film, polypropylene fabric, and any other materials adapted to enclose and maintain the integrity of the contents of the resealable bag 100 may be used. In certain embodiments, the panel 106 may be fabricated using one material. In alternative embodiments, the panel 106 may be fabricated using a combination of materials. A skilled artisan may select any shape, size, and configuration for the panel 106, as desired. In certain embodiments, more than one panel 106 may be used to form the main body 102.

In a most particular embodiment, as shown in FIG. 2, the panel 106 may include a front panel section 108, a rear left panel section 110, and a rear right panel section 112. The front panel section 108, rear left panel section 110, and rear right panel section 112 may be integral with one another or separate components that are permanently or removably connected to one another according to various embodiments of the present disclosure. A skilled artisan may select any number of panel sections having any desirable shape, size, and configuration.

In certain embodiments, the panel 106 may include one or more layers 114. Any suitable number of layers 114 may be selected by a person of skill in the art. Each layer 114 may be fabricated using one or more materials, and in certain embodiments including more than one layer 114, each layer 114 may be identical to one another or different according to various embodiments of the present disclosure.

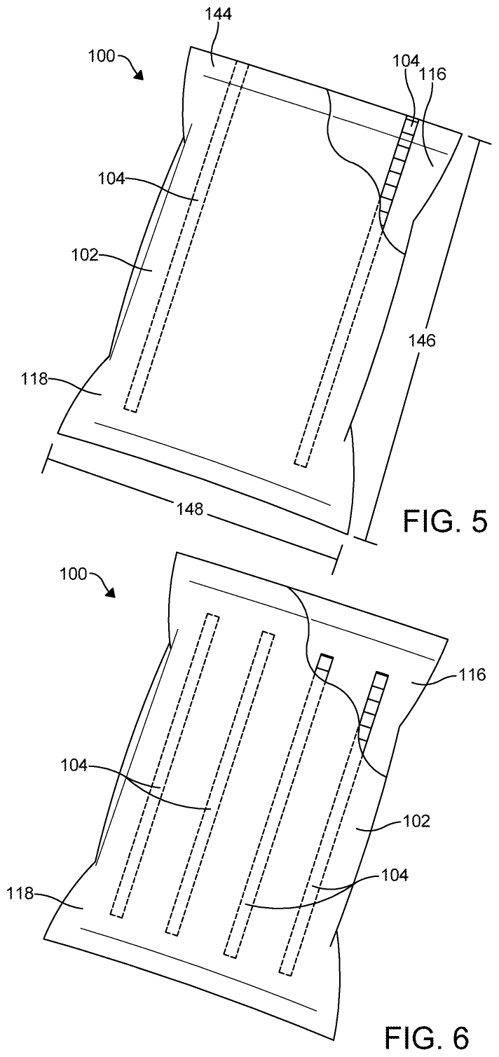

As a non-limiting example, as shown in FIGS. 5 and 6, the panel 106 may be formed using two layers 114, an inner layer 116 and an outer layer 118. In certain embodiments, as shown in FIG. 3, the panel 106 may include a plurality of layers 114. Suitable materials may include, but are not limited to sealant, thermoplastic resins such as biaxially oriented polypropylene (BOPP) and low-density polyethylene (LDPE), metalized biaxially oriented polypropylene (MET BOPP), paper, synthetic paper, overprint varnish (OPV), plastic, polymer films, aluminum foil, cellulosic film, bioplastic film, polypropylene fabric, Surlyn®, and any other suitable material. In a more particular embodiment, with renewed reference to FIG. 3, the panel may include a layer of OPV varnish 120, a layer of synthetic paper 122, a layer of LDPE 124, a layer of MET BOPP 126, and a layer of sealant 128, as non-limiting examples. Any suitable number and combination of layers 114 may be selected to form the panel 106, as desired, using any suitable materials.

The main body 102 may include one or more seals 130 according to various embodiments of the present disclosure. Each seal 130 is adapted to, in combination with the panel 106, form the main body 102 of the resealable bag 100 and contain the contents of the resealable bag 100. In certain embodiments, the one or more seals 130 may be broken by a user to access the contents of the resealable bag 100. The main body 102 may include one or more fin seals, lap seals, heat seals, or any other suitable types of seals, as non-limiting examples. A skilled artisan may select any suitable number of seals 130, orientation of seals 130, for example, vertical and horizontal, and type or combination of types of seals 130 for the resealable bag 100, as desired. Each seal 130 may be formed using any suitable adhesive, glue, or other bonding agent or mechanism, as non-limiting examples, or any combination thereof.

The combination of the panel 106 and the one or more seals 130 may form a square, tubular, vertically rectangular, horizontally rectangular, or any other geometrically shaped main body 102 of the resealable bag 100. The present disclosure contemplates any variety of shapes, sizes, and configurations for the resealable bag 100, as determined by a person skilled in the art.

The at least one flexible member 104 may be fabricated from any suitable flexible material or combination of materials according to various embodiments of the present disclosure. The flexible material may be malleable such that the user of the resealable bag 100 is able to position the at least one flexible member 104 in a deformed shape 132, as needed. The flexible material may also be sufficiently rigid so as to maintain the deformed shape 132. In other words, the at least one flexible member 104 will maintain the deformed shape 132 until the user repositions the at least one flexible member 104.

The at least one flexible member 104 may be any shape and size, as determined by one of skill in the art. Additionally, the dimensions of the at least one flexible member 104 may be any suitable dimensions for the desired end use. A person skilled in the art may select any desired length, width, malleability, and configuration for the at least one flexible member 104 based on the specifications of the main body 102 of the resealable bag 100 and, if needed, the contents of the resealable bag 100. Likewise, it should be appreciated that the number of flexible members 104 and the placement and positioning of the flexible members 104 within or on the main body 102 of the resealable bag 100 may be selected by one skilled in the art and scalable to the desired end use. As an example, a resealable bag 100 having a larger main body 102 or that is made using a thicker material may require additional flexible members 104 or flexible members 104 that are larger in size, for example, compared to a resealable bag 100 having a smaller main body 102.

As a non-limiting example, as shown in FIGS. 2-4, the at least one flexible member 104 may be a tin tie, and the flexible material may be galvanized steel wire. A skilled artisan may select other suitable flexible members 104 including flexible materials or a combination of flexible and non-flexible materials. For example, aluminum, copper, silver, and any other malleable materials may be used for the at least one flexible member 104, as desired. Likewise, plastic, paper, silicone, and other suitable materials may also be used in combination with one or more flexible, malleable materials. In certain embodiments, the at least one flexible member 104 may include one or more non-flexible materials in combination with one or more flexible materials.

As another non-limiting example, the at least one flexible member 104 may be a layer 114 of flexible material, or a layer 114 of flexible material including at least one flexible member 104. A malleable material such as aluminum foil, as a non-limiting example, or any other suitable material or combination of materials may be used, as determined by one of skill in the art.

In a more particular embodiment, as shown in FIGS. 1D and 2, a first end 134 of the panel 106 may be adapted to overlap a second end 136 of the panel 106 to form a vertical seal 138. The main body 102 may also include a bottom seal 142 and a top seal 144. The panel 106, in combination with the vertical seal 138, bottom seal 142, and top seal 144, is adapted to keep the contents properly stored prior to the user breaking one or more of the seals 130, for example, the top seal 144. The flexible member 104 may be disposed on one or both of the first end 134 and the second end 136 of the panel 106. In certain embodiments, the flexible member 104 may be held in place once the vertical seal 138 is formed, for example, in a cavity 140 formed by the vertical seal 138. Alternatively, in certain embodiments, the flexible member 104 may be integral with or permanently or removably connected to one or both of the first end 134 and the second end 136 of the panel 106 before or when the vertical seal 138 is formed. A skilled artisan may use any suitable means for affixing and securing the flexible member 104 to the main body 102 of the resealable bag 100, as desired. As non-limiting examples, glue or any other adhesive or other bonding agent may be used. Alternatively, the flexible member 104 may be affixed to the outside of the vertical seal 138. In certain alternative embodiments, more than one flexible member 104 may be affixed to the inside or the outside of the vertical seal 138. In alternative embodiments, more than one flexible member 104 may be disposed across a length 146 of the resealable bag 100, as shown in FIGS. 5 and 6, a width 148 of the resealable bag 100, or within one or more seals 130 at the front, rear, top, bottom, or sides of the resealable bag 100.

In another embodiment of the present disclosure, with renewed reference to FIGS. 5 and 6, at least one flexible member 104 may be disposed between one or more layers 114 of the main body 102 of the resealable bag 100. In a more particular embodiment, the resealable bag 100 may have at least one flexible member 104 disposed between the inner layer 116 and the outer layer 118 such that the at least one flexible member 104 is sandwiched between at least the inner layer 116 and the outer layer 118. In certain embodiments, additional layers 114 may be disposed next to one or both of the inner layer 116 and the outer layer 118, as desired.

Any suitable number of flexible members 104 in any desired shape and size may be used. Likewise, any suitable material or combination of materials may be used for the flexible members 104. The flexible members 104 may be arranged in any desirable position or configuration, as determined by one of skill in the art. The desired end use of the resealable bag 100, the contents being stored, and the size and the material of the resealable bag 100, for example, may be used to determine the type, number, and configuration of the flexible members 104.

The at least one flexible member 104 may be held in place using glue or any other adhesive or other bonding agent, as non-limiting examples. In a more particular embodiment, the at least one flexible member 104 may be held in place by lamination between layers 114 of the main body 102 of the resealable bag 100. In certain embodiments, the at least one flexible member 104 may be disposed in one or more cavities (not shown) formed between layers 114 of the main body 102 of the resealable bag 100. The at least one flexible member 104 may be secured to the main body 102 of the resealable bag 100 using adhesive or lamination between two or more layers 114, one or more cavities or seals 130, or any combination of securing means. The at least one flexible member 104 may be integral with or permanently or removably connected to one or more layers 114 of the resealable bag 100. In certain embodiments where the at least one flexible member 104 is removably connected to the resealable bag 100, the at least one flexible member 104 may be positioned and repositioned by the user throughout the life of the resealable bag 100. In certain alternative embodiments, the at least one flexible member 104 may be affixed to the outside of the resealable bag 100 or the inside of the resealable bag 100.

The at least one flexible member 104 may be oriented vertically, horizontally, diagonally, or in any other suitable orientation, as well as any combination of suitable configurations, as determined by one of skill in the art. In certain embodiments, the at least one flexible member 104 may extend across the entire length 146 or the entire width 148 of the resealable bag 100. In other embodiments, the at least one flexible member 104 may extend from the top seal 144 to the bottom seal 142 of the resealable bag 100, as shown in FIG. 6, from the bottom seal 142 to the top of the resealable bag 100, as shown in FIG. 5, or any other desired length. In certain embodiments having multiple flexible members 104, the flexible members 104 may be identical to one another. In certain alternative embodiments having multiple flexible members 104, the flexible members 104 may have variable sizes, shapes, and configurations, and may also be made from the same or different material or materials.

In a more particular embodiment, the at least one flexible member 104 may be disposed in a sealant layer 128 of the main body 102. In yet another more particular embodiment, the at least one flexible member 104 may be embedded in a thermoplastic sheet layer 114.

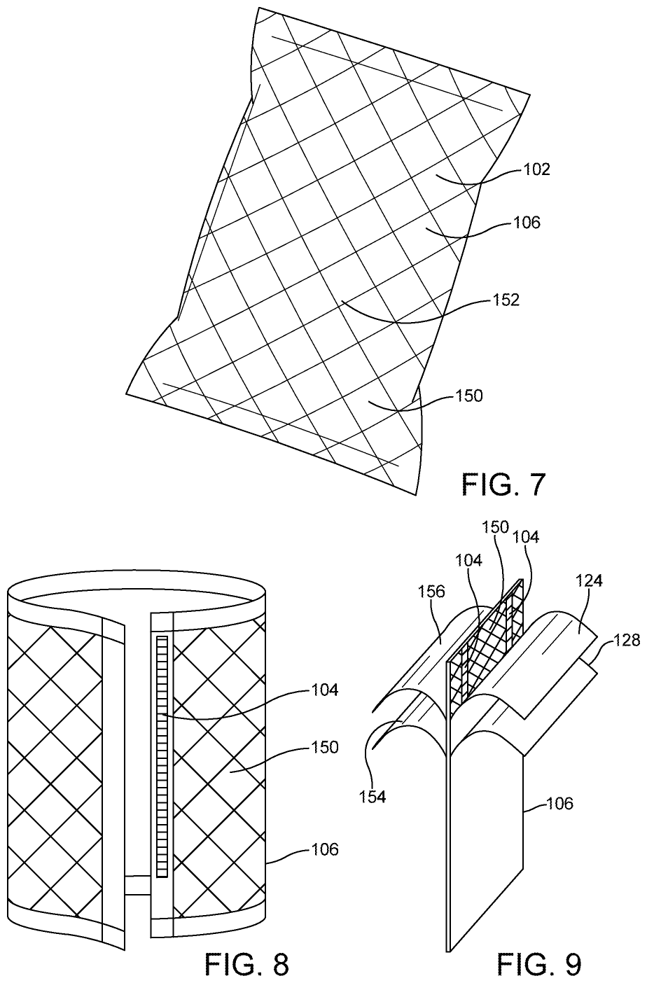

In yet another more particular embodiment, the at least one flexible member 104 may be a flexible resealing layer 150 fabricated from one or more malleable materials. Accordingly, the resealing layer 150 may retain a shape upon being manipulated by the user. As one non-limiting example, aluminum foil may be used. The resealing layer 150 may be disposed between two or more layers 114. The resealing layer 150 may be the inner layer 116 of the resealable bag 100 or the outer layer 118 of the resealable bag 100, according to various embodiments of the present disclosure. In certain embodiments, the main body 102 may be fabricated using one layer 114, the resealing layer 150. The resealing layer 150 may be a sheet of thermoplastic material with at least one flexible member 104 embedded therein, according to various embodiments of the present disclosure. In certain alternative embodiments of the present disclosure, the resealing layer 150 may be a sealant layer 128 embedded with at least one flexible member 104. In certain embodiments, one or both of the resealing layer 150 and the at least one flexible member 104 may be in a diamond lattice pattern 152, for example, as shown in FIGS. 7-9. In certain alternative embodiments of the present disclosure, the resealing layer 150 may be a layer 114 of flexible material that may be embedded with at least one flexible member 104.

In certain embodiments, with reference to FIG. 9, the resealing layer 150 may be sandwiched between layers 114 of the main body 102. In a more particular embodiment, the resealing layer 150 may be disposed between a layer of BOPP 156 and a layer of LDPE 124. The resealing layer 150, the layer of BOPP 156, and the layer of LDPE 124 may be further sandwiched between a layer of Surlyn® 154 and a layer of MET BOPP 126, as one non-limiting example of a main body 102. In yet another embodiment, a laminate aluminum foil may be applied to the panel 106 or a portion of the panel 106 such as the rear left panel section 110, the rear right panel section 112, or the front panel section 108, as non-limiting examples. It should be appreciated that any malleable material, in combination with other materials or alone, may be used to form a resealing layer 150 in the panel 106 or in a portion of the panel 106.

It should be appreciated that the resealing layer 150 may be disposed along the length 146 and the width 148 of the resealable bag 100. The resealing layer 150 may extend the entire length 146 and width 148 of the panel 106 that forms the main body 102 of the resealable bag 100, as shown in FIG. 7, or the resealing layer 150 may extend only a portion of the length 146 and the width 148 of the panel 106 that forms the main body 102 of the resealable bag 100. For example, the resealing layer 150 may be disposed spaced apart from a top and a bottom of the resealable bag 100, as shown in FIG. 8. It should be appreciated that the resealing layer 150 does not need to be disposed centrally along the length 146 or the width 148 of the resealable bag 100. In other words, the resealing layer 150 may be disposed nearer to the top of the resealable bag 100 than the bottom of the resealable bag 100, as it is not necessary to reseal the bottom of the resealable bag 100 according to certain embodiments of the present disclosure. As another non-limiting example, the resealing layer 150 may be disposed in only the front panel section 108 or any other panel section. A skilled artisan may select any suitable placement for the resealing layer 150, as desired.

In a more particular embodiment of the present disclosure, the resealable bag 100 includes a resealing layer 150 and at least one flexible member 104 disposed in the vertical seal 138 of the main body 102 of the resealable bag 100. In yet another more particular embodiment, the resealable bag 100 includes a resealing layer 150 with at least one flexible member 104 disposed or embedded on the resealing layer 150, as shown in FIG. 9.

In operation, the user may access the resealable bag 100 in a closed, un-opened first position 158. The user may open the resealable bag 100, breaking one or more of the seals 130, in order to gain access to the contents of the resealable bag 100 through an opening 160. After obtaining the desired contents from the resealable bag 100, the user may close the resealable bag 100 and store the contents of the resealable bag 100 for a period of time. To do so, the user may roll or fold the resealable bag 100 thereby closing the opening 160. The roll or fold positions the at least one flexible member 104 in the deformed shape 132. As described hereinabove, the at least one flexible member 104 maintains the deformed shape 132, thereby, holding the resealable hag 100 in a re-sealed, closed second position 162. To regain access to the contents of the resealable bag 100, the user may unroll or unfold the at least one flexible member 104 of the resealable bag 100, thereby placing the resealable bag 100 in an unrolled and unsealed, open third position 164, as shown in FIG. 1C, such that the user may gain access to the contents of the resealable bag 100 through the opening 160 again. The resealable bag 100 is selectively positionable between the unrolled and unsealed, open third position 164 and the re-sealed, closed second position 166. Accordingly, even where the resealable bag 100 is shaken, jostled, or flipped upside down, the at least one flexible member 104 will hold the resealable bag 100 in the re-sealed, closed second position 162, as desired. Advantageously, this militates against undesirable spills of the contents of the resealable bags 100, in operation, and removes any unused space in the resealable bag 100 during storage leaving a progressively smaller, neater resealable bag 100 for storage.

It should be appreciated that the resealable bag 100 may be repeatedly opened and closed, as desired. The flexible material of the at least one flexible member 104 allows for repeated deformations without a reduction in strength. Accordingly, the user may place the resealable bag 100 in the re-sealed, closed second position 162 at any level along the bag allowing the resealable bag 100 to be automatically sealed at any level. The at least one flexible member 104 allows the resealable bag 100 to be repeatedly sealed and unsealed as desired without the use of an additional closing or sealing mechanism. The resealable bag 100 may be roll-up, folded, and closed easily and quickly. In certain embodiments, at least one flexible member 104 may be positioned vertically, horizontally, or in any other suitable orientation and adaptable to any amount of contents within the resealable bag 100. The resealable bag 100 may be sealed at any level. The at least one flexible member 104 may allow the resealable bag 100 to be “self-locking,” such that no additional clip or tie is needed to reseal and keep the resealable bag 100 closed.

In certain embodiments, the at least one flexible member 104 may be cut or torn by the user. In other words, the user may remove a desired portion of the resealable bag 100 in order to more easily access to the contents of the resealable bag 100. Even where the at least one flexible member 104 has been cut or torn, the user may still roll the resealable bag 100 into the re-sealed, closed second position 162. Advantageously, the user may remove extra packaging that may take up additional space or impede access to the contents of the resealable bag 100 without hindering the sealing capabilities of the resealable bag 100.

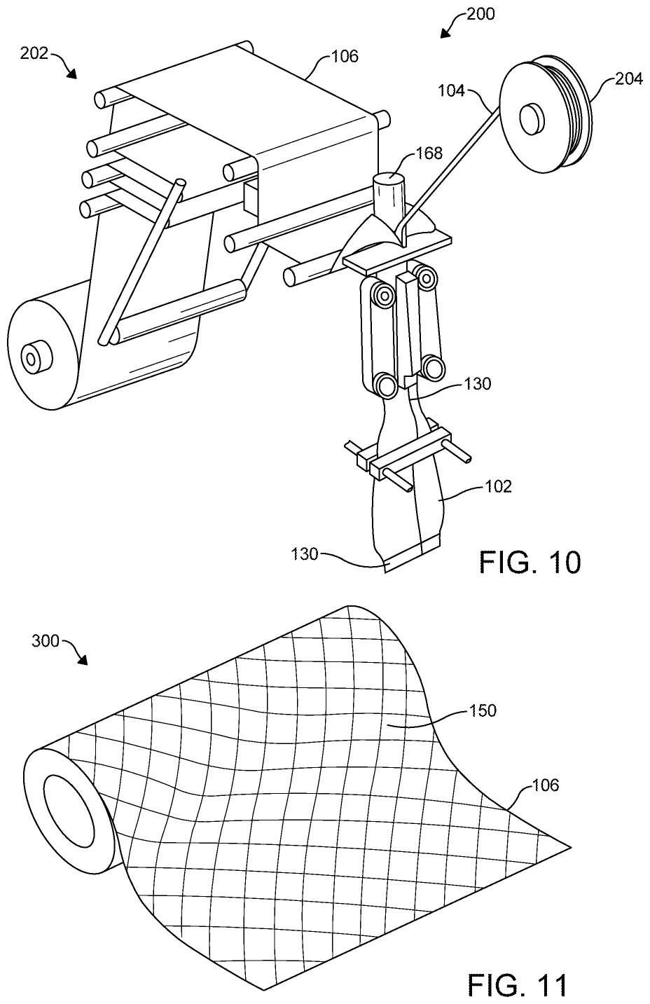

In yet another embodiment, a system 200 and method for manufacturing the resealable bag 100, as shown in FIG. 10, may include an automated machine 202. As non-limiting examples, a form fill sealing machine, a vertical form fill sealing machine, a horizontal form fill sealing machine, or any other pipe driven or other suitable machine may be used to form the main body 102 of the resealable bag 100. The resealable bag 100 may have various configurations such as pillow, gusset, box bottom, or pouch, as non-limiting examples. The system 200 may also include a spool 204 or other device suitable for delivering or dispensing the at least one flexible member in communication with the automated machine 202. The spool 204 may include at least one flexible member 104 that is directly fed into a seal 130 formed in the main body 102 of the resealable bag 100 by the automated machine 202. The spool 204 may be in electrical communication with a control unit (not shown), and the spool 204 and the control unit may be designed and retrofitted to a vertical form fill sealing machine, a horizontal form fill sealing machine, or any other suitable automated machine 202, per individual machine schematics, as desired. In certain embodiments, any suitable applicator or retrofitted component may be added to or included with the automated machine 202. It should be appreciated that any suitable automated machine 202 used to manufacture a resealable bag 100 and any suitable mechanism for delivering the at least one flexible member 104 to the automated machine 202 may be used. In certain embodiments, more than one spool 204 and more than one flexible member 104 may be used with the automated machine 202.

In certain more particular embodiments of the present disclosure, a direct vertical feed of the at least one flexible member 104 to a fin, lap, or other seal 130 may be either continuous or registered, as non-limiting examples. The system 200 and method may be used on all sealant-type applications. It should be appreciated that the system 200 and method is not necessarily machine-dependent, and any suitable machine that produces a resealable bag 100 having one or more seals 130, cavities, adhesives, or other means for connecting to the at least one flexible member 104 may also be employed. In particular, any suitable automated machine 202 creating a seal 130 in combination with any suitable means for feeding the at least one flexible member 104 into the seal 130, in any direction, as desired, may be used within the scope of the present disclosure. In another more particular embodiment, the spool 204 may directly feed the at least one flexible member 104 between two or more layers 114 of the main body 102 of the resealable bag 100 prior to any seals 130 being formed such that the at least one flexible member is disposed between, embedded in laminated between, or otherwise secured between at least two layers 114 of the resealable bag 100.

In another more particular embodiment of the present disclosure, a system (not shown) may include an automated machine 202 used to form the main body 102 of the resealable bag 100 and a roll 300 of flexible material, as shown in FIG. 11, used to form the panel 106 that is formed into the main body 102 of the resealable bag 100. In certain embodiments, the roll 300 of flexible material used to form the panel 106 may include more than one layer, and the at least one flexible member 104 may be disposed on or in between one or more of the layers 114 that make up the panel 106 of the resealable bag 100. In certain alternative embodiments, the roll 300 of flexible material used to make the panel 106 may include a flexible resealing layer 150 fabricated from one or more malleable materials. As one non-limiting example, aluminum foil may be used. The resealing layer 150 may be disposed between two or more layers 114 included in the panel 106. The resealing layer 150 may be the inner layer 116 of the resealable bag 100 or the outer layer 118 of the resealable bag 100, according to various embodiments of the present disclosure. In certain embodiments, the main body 102 may be fabricated from a single layer 114 that is the resealing layer 150. The resealing layer 150 may be a sheet of thermoplastic material with at least one flexible member 104 embedded therein, according to various embodiments of the present disclosure. In certain alternative embodiments, the resealing layer 150 may be a sealant layer 128 with at least one flexible member 104 disposed or embedded on the sealant layer 128.

The roll 300 of flexible material used to form the panel 106 may be automatically fed into the automated machine 202 and around a tube 168, for example, a cone-shaped tube 168, as a non-limiting example. The tube 168 may then form the main body 102 of the resealable bag 100 by wrapping the panel 106 around the tube 168 and forming the necessary seals 130. Prior to forming a final seal 130, the contents may be distributed into the resealable bag 100. In certain embodiments, the roll 300 of flexible material used to form the panel may be used in the system 200 and method for manufacturing the resealable bag 100 shown in FIG. 10. Accordingly, in certain more particular embodiments, the resealable bag 100 may include both a resealing layer 150 and at least one flexible member 104 disposed in a seal 130 disposed on the main body 102 of the resealable bag 100, as shown in FIG. 8.

In another embodiment of the present disclosure, a system (not shown) for manufacturing a resealable bag 100 includes a dispensing mechanism for a panel 106 of flexible material and an automated machine 202 for forming the panel 106 of flexible material into a resealable bag 100. It should be appreciated that the dispensing mechanism, according to certain embodiments, may produce the panel 106 of flexible material having a flexible member 104 that is one of attached to the flexible material of the panel 106, disposed on the flexible material of the panel 106, and embedded in the flexible material of the panel 106. Alternatively, the panel 106 of flexible material may be premanufactured to include the flexible member 104 that is one of attached to the flexible material of the panel 106, disposed on the flexible material of the panel 106, and embedded in the flexible material of the panel 106. In another embodiment of the present disclosure, a spool 204 or any other suitable dispensing mechanism may be included in the system for manufacturing a resealable bag 100. The spool 204 is adapted to dispense the flexible member 104 such that the flexible member 104 is one of attached to the flexible material of the panel 106, disposed on the flexible material of the panel 106, and embedded in the flexible material of the panel 106 when the panel 106 of flexible material is formed into the resealable bag 100 by the automated machine 202.

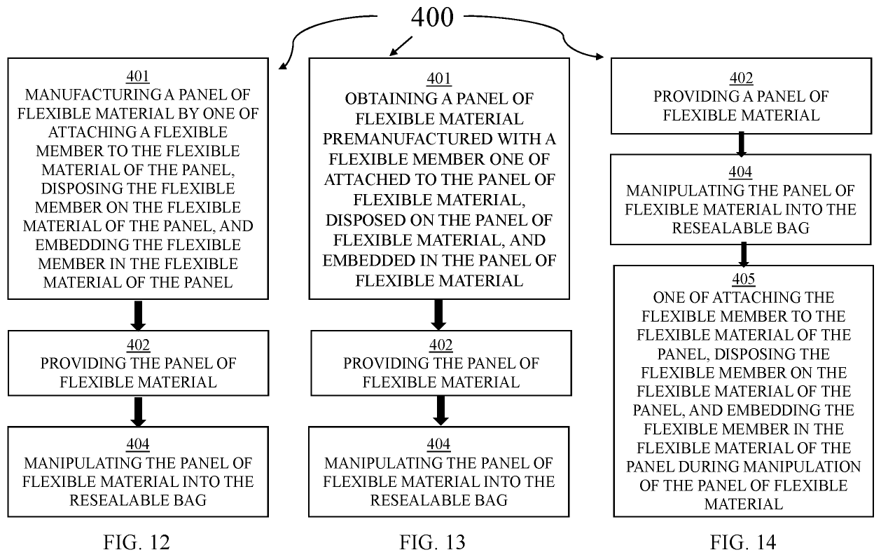

With reference to FIGS. 12-14, a method 400 of making a resealable bag 100, according to various embodiments, is shown. The method 400 of making the resealable bag 100 includes a first step 402 of providing a panel 106 of flexible material. The method 400 further includes a second step 404 of manipulating the panel 106 into a resealable hag 100. It should be appreciated that the first step 402 of providing the panel 106 of flexible material may be accomplished by a step 401 of either manufacturing the panel 106 by one of attaching a flexible member 104 to the flexible material of the panel 106, disposing the flexible member 104 on the flexible material of the panel 106, and embedding the flexible member 104 in the flexible material of the panel 106, or by obtaining the panel 106 of flexible material premanufactured with the flexible member 104 one of attached to the flexible material of the panel 106, disposed on the flexible material of the panel 106, and embedded in the flexible material of the panel 106. In either case, attaching the flexible member 104 to the panel 106, disposing the flexible member 104 on the panel 106, and embedding the flexible member 104 in the panel 106 may be accomplished by various means including, but not limited to, employment of the system 200 as described herein. It should be appreciated that the flexible member 104 may be installed on or in the resealable bag 100 during the second step 404 while the panel 106 of flexible material is being manipulated to form the resealable bag 100. In certain embodiments, the second step 404 may include a step 405 of one of attaching the flexible member 104 to the flexible material of the panel 106, disposing the flexible member 104 on the flexible material of the panel 106, and embedding the flexible member 104 in the flexible material of the panel 106 during formation of the resealable bag 100.

It should be appreciated that any other suitable constructions, systems, and methods for manufacturing the resealable bag 100 may be contemplated in the present disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A resealable bag, comprising:
a main body; and
at least one flexible member that is one of attached to the main body, disposed on the main body, and embedded in the main body;
wherein the resealable bag is selectively positionable between an open, unsealed position, and a closed, sealed position; and
wherein when the resealable bag is in the closed, sealed position, the at least one flexible member is in a deformed shape.

2. The resealable bag of claim 1, wherein the main body is formed from a panel having at least one layer, the panel having a first end that overlaps a second end to form a vertical seal.

3. The resealable bag of claim 2, wherein the at least one flexible member is disposed on the vertical seal.

4. The resealable bag of claim 3, wherein the at least one flexible member is at least one tin tie.

5. The resealable bag of claim 2, wherein the panel includes at least a first layer and a second layer, and wherein the at least one flexible member is secured between the first layer and the second layer.

6. The resealable bag of claim 2, wherein the panel includes at least a first layer and a second layer, and wherein the at least one flexible member is laminated between at least the first layer and the second layer.

7. The resealable bag of claim 1, wherein the main body is formed from a panel having a plurality of layers, wherein the plurality of layers includes a member selected from a group consisting of sealant, thermoplastic resin, biaxially oriented polypropylene, metalized biaxially oriented polypropylene, paper, synthetic paper, overprint varnish, plastic, polymer film, aluminum foil, cellulosic film, bioplastic film, polypropylene fabric, Surlyn®, and combinations thereof.

8. The resealable bag of claim 1, wherein the main body is formed from a panel having at least one sealant layer, and wherein the at least one flexible member is disposed on the at least one sealant layer.

9. The resealable bag of claim 1, wherein the main body is formed from a panel having at least one thermoplastic sheet layer, and wherein the at least one flexible member is embedded in the at least one thermoplastic sheet layer.

10. The resealable bag of claim 1, wherein the at least one flexible member extends from a bottom seal of the resealable bag to a top seal of the resealable bag.

11. The resealable bag of claim 1, wherein the at least one flexible member extends from a bottom end of the resealable bag to a top end of the resealable bag.

12. The resealable bag of claim 1, wherein the at least one flexible member includes a resealing layer made from a flexible, malleable material.

13. The resealable bag of claim 12, wherein the resealing layer includes aluminum foil.

14. The resealable bag of claim 12, wherein the resealing layer is laminated between at least an outer layer and an inner layer.

15. The resealable bag of claim 1, wherein the at least one flexible member includes a resealing layer and at least one second flexible member embedded in the resealing layer.

16. The resealable bag of claim 2, wherein the panel includes a layer of plastic film, a layer of BOPP, a resealing layer made from a flexible, malleable material, a layer of LDPE, and a layer of MET BOPP.

17. The resealable bag of claim 1, wherein the at least one flexible member includes a resealing layer made from a flexible, malleable material, and a second flexible member is disposed in one of a vertical seal and a horizontal seal of the main body.

18. A system for manufacturing a resealable bag, the system comprising:
a dispensing mechanism adapted to dispense a panel of flexible material; and
a machine adapted to form the panel of flexible material into the resealable bag;
wherein the resealable bag has a main body and a flexible member that is one of attached to the panel of flexible material, disposed on the panel of flexible material, and embedded in the panel of flexible material.

19. The system of claim 18, wherein the flexible member is one of attached to the panel of flexible material, disposed on the panel of flexible material, and embedded in the panel of flexible material by one of the dispensing mechanism, providing a premanufactured panel of flexible material, and a second dispensing mechanism in communication with the machine, wherein the second dispensing mechanism is adapted to dispense the flexible member to the machine during formation of the resealable bag.

20. A method of manufacturing a resealable bag, the method comprising the steps of:
providing a panel of flexible material; and
manipulating the panel of flexible material into the resealable bag;
wherein the resealable bag has a main body and a flexible member that is one of attached to the panel of flexible material, disposed on the panel of flexible material, and embedded in the panel of flexible material.
